(19) United States
(12) Patent Application Publication
(10) Pub. No.: US 2023/0082140 A1
(43) Pub. Date: Mar. 16, 2023

(54) RELATIONSHIP EXTRACTION APPARATUS, RELATIONSHIP EXTRACTION METHOD, AND PROGRAM

(71) Applicant: Nippon Telegraph and Telephone Corporation, Tokyo (JP)

(72) Inventors: Yuka HASHIMOTO, Musashino-shi, Tokyo (JP); Isao ISHIKAWA, Matsuyama-shi, Ehime (JP); Masahiro IKEDA, Setagaya-ku, Tokyo (JP); Yoshinobu KAWAHARA, Fukuoka-shi, Sawara-ku, Fukuoka (JP); Takeshi KATSURA, Chuo-ku, Tokyo (JP); Fuyuta KOMURA, Chuo-ku, Tokyo (JP)

(21) Appl. No.: 17/801,785

(22) PCT Filed: Feb. 22, 2021
(86) PCT No.: PCT/JP2021/006689

§ 371 Date: Aug. 23, 2022

(30) Foreign Application Priority Data
Mar. 2, 2020 (JP) 2020-035051

(51) Int. Cl. G06N 20/10

(52) U.S. Cl. CPC G06N 20/10

(57) ABSTRACT

A relationship extraction device includes a memory; and a processor configured to execute obtaining a set of data {x₀, . . . , x_{T-1}}⊆X each having multiple elements and a set of data {y₀=f(x₀), . . . , y_{T-1}=f(x_{T-1})}⊆Y each having multiple elements, where f is any mapping; generating an approximate operator that approximates a Perron-Frobenius operator K satisfying Kφ₁(xₜ)=φ₂(yₜ) for t=0, . . . , T−1, wherein φ₁ is a feature mapping with respect to a positive definite kernel function k₁ on X×X that takes C*-algebra values, and φ₂ is a feature mapping with respect to a positive definite kernel function k₂ on Y×Y that takes C*-algebra values; obtaining data xₜ and xₛ as targets of relationship extraction; and extracting a relationship between each element of xₜ and each element of xₛ by using the approximate operator.

### TECHNICAL FIELD

The present invention relates to a relationship extraction device, a method of extracting relationship, and a program.

### BACKGROUND ART

For data having multiple elements, investigation of correlations between elements has been conducted in various technical fields (e.g., in the fields of the statistics, machine learning, molecular dynamics, etc.).

For example, in the field of statistics and machine learning, techniques have been proposed in which vectors having multiple elements of data arranged are mapped to a space called vv-RKHS (vector-valued reproducing kernel Hilbert space), to approximate a function that represents a relationship between the elements on the vv-RKHS (Non-patent document 1). As the vv-RKHS is a space of vector-valued functions, it has an advantage of being capable of approximating the relationship among multiple elements at once. Note that techniques have been also proposed that extract information on cyclic components from time series data that represents change in time of the relationship by using the vv-RKHS for time series data (Non-patent document 2).

Also, for example, in the field of physics and molecular dynamics, techniques have been proposed that extract information on collective oscillations by a method called phase reduction (Non-patent document 3). Also, for example, in the field of machine learning, methods have been proposed that extract variables in a causality relationship by a method called Granger causality (Non-patent document 4).

The vv-RKHS described above is a generalization of the RKHS (reproducing kernel Hilbert space) used for analyzing data having a single element. By using the RKHS, data exhibiting complex behavior can be converted into data exhibiting simple behavior. Using this property, techniques have been studied that approximate complex time series data with a simple function on the RKHS (Non-patent document 5).

Here, as another generalization of the RKHS, a space called RKHM (reproducing kernel Hilbert C*-module) has been proposed, and theoretical analysis has been conducted in the field of physics (Non-patent document 6). The RKHM is a space of functions having values in a space called C*-algebra, and hence, can be used for approximating a C*-algebra-valued function. Note that C*-algebra is a generalization of a set of all complex numbers and a set of all matrices, and is a space having the concepts of conjugation and norm.

### RELATED ART DOCUMENTS

### Non-Patent Document

[Non-patent document 1] Mauricio A. Alvarez, Lorenzo Rosasco, and Neil D. Lawrence, ‘Kernels for vector-valued functions: a review,’ Computer Science and Artificial Intelligence Laboratory Technical Report, MIT-CSAIL-TR-2011-033 CBCL-301, 2011.
[Non-patent document 2] Keisuke Fujii, Yoshinobu Kawahara, ‘Dynamic mode decomposition in vector-valued reproducing kernel Hilbert spaces for extracting dynamical structure among observables,’ Neural Networks 117, pp. 94-103, 2019.
[Non-patent document 3] Hiroya Nakao, Sho Yasui, Masashi Ota, Kensuke Arai and Yoji Kawamura, ‘Phase reduction and synchronization of a network of coupled dynamical elements exhibiting collective oscillations,’ Chaos 28, 045103, 2018.
[Non-patent document 4] Songting Li, Yanyang Xiao, Douglas Zhou and David Cai, ‘Causal inference in nonlinear systems: Granger causality versus time-delayed mutual information,’ Phys. Rev. E 97, 052216, 2018.
[Non-patent document 5] Yuka Hashimoto, Isao Ishikawa, Masahiro Ikeda, Yoichi Matsuo and Yoshinobu Kawahara, ‘Krylov Subspace Method for Nonlinear Dynamical Systems with Random Noise,’ arXiv: 1909.03634, 2019.
[Non-patent document 6] Jaeseong Heo, ‘Reproducing kernel Hilbert C*-modules and kernels associated with cocycles,’ J. Math. Phys. 49, 103507, 2008.

### SUMMARY OF THE INVENTION

### Problem to be Solved by the Invention

Meanwhile, the RKHS is only capable of handling data having a single element, and hence, cannot describe a relationship among multiple elements. Also, the phase reduction aims at approximating collective behavior of data, and hence, cannot represent a relationship among elements. On the other hand, although the vv-RKHS takes a relationship among multiple elements into consideration, the proximity between vector-valued functions included in the vv-RKHS is measured in complex values. Therefore, for example, in the case where the purpose is to completely extract information on the relationship of any two elements from among the multiple elements, the number of relationships between the two data items each having n elements becomes n², and hence, it becomes necessary to represent the proximity of functions corresponding to these data items n² complex numbers.

In contrast, if using the RKHM, the proximity of functions can be measured by a C*-algebra value of a matrix or the like. However, there is no framework of using the RKHM that aims at extracting relationships between elements of data having multiple elements.

One embodiment of the present invention was devised in view of the above points, and has an object to extract relationships between elements held in data using the RKHM.

### Means for Solving Problem

As described above, in order to achieve the object, a relationship extraction device according to one embodiment includes a first obtaining means configured to obtain a set of data {x₀, . . . , x_{T-1}}⊆X each having multiple elements and a set of data {y₀=f(x₀), . . . , y_{T-1}=f(x_{T-1})}⊆Y each having multiple elements, where f is any mapping; a generation means configured to generate an approximate operator that approximates a Perron-Frobenius operator K satisfying Kφ₁(xₜ)=φ₂(yₜ) for t=0, . . . , T−1, wherein φ₁ is a feature mapping with respect to a positive definite kernel function k₁ on X×X that takes C*-algebra values, and φ₂ is a feature mapping with respect to a positive definite kernel function k₂ on Y×Y that takes C*-algebra values; a second obtaining means configured to obtain data xₜ and xₛ as targets of relationship extraction; and an extraction means configured to extract a relationship between each element of xₜ and each element of xₛ by using the approximate operator.

### Advantageous Effects of the Invention

Relationships between elements held in data can be extracted using the RKHM.

### BRIEF DESCRIPTION OF THE DRAWINGS

FIG. 1 is a diagram illustrating an example of a functional configuration of a relationship extraction device according to a present embodiment;

FIG. 2 is a flow chart illustrating an example of an approximate operator generation process according to the present embodiment;

FIG. 3 is a flow chart illustrating an example of a relationship extraction process according to the present embodiment;

FIG. 4A is a diagram (part 1) illustrating an example of an evaluation result;

FIG. 4B is a diagram (part 1) illustrating an example of an evaluation result;

FIG. 5A is a diagram (part 2) illustrating an example of an evaluation result;

FIG. 5B is a diagram (part 2) illustrating an example of an evaluation result;

FIG. 5C is a diagram (part 2) illustrating an example of an evaluation result;

FIG. 5D is a diagram (part 2) illustrating an example of an evaluation result;

FIG. 6A is a diagram (part 3) illustrating an example of an evaluation result;

FIG. 6B is a diagram (part 3) illustrating an example of an evaluation result;

FIG. 7A is a diagram (part 4) illustrating an example of an evaluation result;

FIG. 7B is a diagram (part 4) illustrating an example of an evaluation result; and

FIG. 8 is a diagram illustrating an example of a hardware configuration of a relationship extraction device according to the present embodiment.

### EMBODIMENTS FOR CARRYING OUT THE INVENTION

In the following, one embodiment of the present invention will be described. In the present embodiment, a relationship extraction device 10 will be described, that can extract a relationship (i.e., interrelation) between any two elements held in data when the data including one or more items each having multiple elements is given, by using an RKHM.

### <Theoretical Construction>

First, a theoretical construction of the present embodiment will be described.

### <<Settings>>

Let X be a space to which data having multiple elements belongs, and let {x₀, x₁, . . . }⊆X be a set of given data. Let A be a C*-algebra, to consider an A-valued positive definite kernel k:X×X→A. Here, when stating that a mapping k:X×X→A is an A-valued positive definite kernel, the mapping satisfies the following Condition 1 and Condition 2.

(Condition 1) For any x,y∈X, k(x,y)=k(x,y)* where * denotes conjugate.
(Condition 2) Let m be any natural number, for any x₀, x₁, . . . , xₘ₋₁∈X and any c₀, c₁, . . . cₘ₋₁∈A, the following double summation is positive.

$$\begin{matrix}[ Math . 1 ] & \\ {\sum }_{t = 0}^{m - 1} {\sum }_{s = 0}^{m - 1} {c}_{t}^{*} k ( {x}_{t} , {x}_{s} ) {c}_{s} & \end{matrix}$$

Here, “positive” means being positive constant in a C*-algebra, which is a generalization of a Hermitian matrix whose all eigenvalues are greater than or equal to 0 (i.e., Hermitian positive definite).

Given an A-valued positive definite kernel k, a mapping φ from X to an A-valued function is defined by φ(x)=k(⋅,x). This mapping (p is also referred to as a feature map.

For a natural number m, x₀, x₁, . . . , xₘ₋₁∈X, and c₀, c₁, . . . , cₘ₋₁∈A, let M_{k,0} be a space configured from the entirety of the following linear combination.

$$\begin{matrix}[ Math . 2 ] & \\ {\sum }_{t = 0}^{m - 1} ϕ ( {x}_{t} ) {c}_{t} & \end{matrix}$$

Also, let m and m′ be natural numbers, x₀, x₁, . . . , xₘ₋₁, y₀, y₁, . . . , y_{m′-1}∈X, and c₀, c₁, . . . , cₘ₋₁, d₀, d₁, . . . , d_{m′-1}∈A, an operation <⋅, ⋅>ₖ with respect to M_{k,0} is defined as follow:

$$\begin{matrix}[ Math . 3 ] & \\ {〈 {\sum }_{t = 0}^{m - 1} ϕ ( {x}_{t} ) {c}_{t} , {\sum }_{t = 0}^{{m}^{′} - 1} ϕ ( {y}_{t} ) {d}_{t} 〉}_{k} = {\sum }_{t = 0}^{m - 1} {\sum }_{s = 0}^{{m}^{′} - 1} {c}_{t}^{*} k ( {x}_{t} , {y}_{s} ) {d}_{s} & \end{matrix}$$

The operation <⋅,⋅>ₖ defined in this way has the properties of the A-valued inner product. In other words, the operation has the following four properties with respect to u,v,w∈M_{k,0} and c,d∈A:
<u,v>ₖ=<v,u>ₖ*
<u,u>ₖ is positive
<u,u>ₖ=0 is equivalent to u=0
<u,vc+wd>ₖ=<u,v>ₖc+<u,w>ₖd

By using this inner product <⋅,⋅>ₖ, a complex-valued norm can be defined as follows:

$$\begin{matrix}[ Math . 4 ] & \\ {‖ v ‖}_{k} = {‖ {〈 v , v 〉}_{k} ‖}^{\frac{1}{2}} & \end{matrix}$$

A space in which M_{k,0} is completed with respect to this norm is denoted as Mₖ, and is referred to as a reproducing kernel Hilbert C*-module (RKHM) with respect to k. Mₖ can be configured uniquely. Also, in Mₖ, the magnitude of an A value |⋅|ₖ can also be defined as follows:

$$\begin{matrix}[ Math . 5 ] & \\ {\vert v \vert}_{k} = {〈 v , v 〉}_{k}^{\frac{1}{2}} & \end{matrix}$$

Assuming that each of xₜ (t=0, 1, . . . ) being an element of X has n elements, xₜ is denoted as xₜ=[x_{t,0}, . . . , x_{t,n-1}]. In the case where a C*-algebra A is the entirety of n×n matrices, an A-valued positive definite kernel k can be configured by using the following complex-valued positive definite kernel:

\tilde{k} [Math. 6]

k

Note that in the text of the present description, for the sake of convenience, a symbol having “˜” added to the top of x is written as “˜x”.

In fact, if each (i,j) component of an n×n matrix k(xₜ,xₛ) is defined by ˜k(x_{t,i},x_{s,j}) with respect to the elements xₜ and xₛ of X, it can be shown that k is an n×n matrix-valued positive definite kernel. ˜k(x_{t,i},x_{s,j}) represents the proximity of x_{t,i} and x_{s,j}; therefore, each (i,j) component of k(xₜ,xₛ) (i.e., the inner product of φ(xₜ) and φ(xₛ)) represents the proximity of the i-th component x_{t,i} of xₜ and the j-th component x_{s,i} of xₛ.

### <<Relationship of Data in RKHM>>

Let X and Y be spaces to which data belongs, and assume that the following Formula (1) holds for x₀, x₁, . . . , x_{T-1}∈X and y₀, y₁ . . . , y_{T-1}∈Y.

yₜ=f(xₜ) (1)

where f is a mapping from X to Y that is nonlinear in general.

Let k₁ be a positive definite kernel on X, let k₂ be a positive definite kernel on Y, let φ₁ be a feature map with respect to k₁, and let φ₂ be a feature map with respect to k₂. In order to express Formula (1) described above as a formula in the following spaces,

Mₖ_{₁},Mₖ_{₂} [Math. 7]

Assume that the following mapping,

K:Mₖ_{₁}→Mₖ_{₂} [Math. 8]

satisfies the following Formula (2),

Kφ₁(xₜ)=φ₂(yₜ) (2)

Such K is referred to as a Perron-Frobenius operator. In the case where x₀, x₁, . . . , x_{T-1}∈X constitute time series data, if setting X=Y, yₜ=xₜ₊₁, and k₁=k₂, then, f is a mapping representing time evolution, and thereby, K is also a mapping representing time evolution.

### <<Approximation of Perron-Frobenius Operator by Orthonormal Projection>>

In the following, it is assumed that an element xₜ (t=0, 1, . . . ) of X has n elements, and is expressed as xₜ=[x_{t,0}, . . . , x_{t,n-1}]. Also, assume that a C*-algebra A is the entirety of n×n matrices, and as described above, an A-valued positive definite kernel k is configured using a complex-valued positive definite kernel ˜k.

At this time, consider approximating K that satisfies Formula (2) describe above, to analyze f by using the approximated K, predict yₜ from a given xₜ, and compare matrix-valued inner products of elements of X obtained by such analysis and prediction (i.e., measure the proximity). The value of an inner product (proximity) takes a matrix value, and its component represents the proximity of elements, and thereby, relationships between the elements can be extracted. In the following, (i) a case of applying a Perron-Frobenius operator K when X=Y, yₜ=xₜ₊₁, and k₁=k₂=k; and (ii) a case of applying the Perron-Frobenius operator K when X*Y, will be described.

(i) The case of X=Y, yₜ=xₜ₊₁, and k₁=k₂=k

In this case, by solving a minimization problem in Formula (3) shown later,

\hat{K} [Math. 9]

is solved to approximate K. Note that in the text of the present description, for the sake of convenience, a symbol having “\hat{ }” added to the top of x is written as “\hat{ }x”.

$$\begin{matrix}[ Math . 10 ] & \\ {min}_{ϕ ( {x}_{t + 1} ) = \hat{K} ϕ ( {x}_{t} ) ( t = 0 , … , T - 2 ) , \hat{K} ∈ L ( {V}_{T} )} {\vert ϕ ( {x}_{T} ) - \hat{K} ϕ ( {X}_{T - 1} ) \vert}_{k} & ( 3 )\end{matrix}$$

where V_{T} is a set of all linear combinations expressed as in the following formula:

$$\begin{matrix}[ Math . 11 ] & \\ {\sum }_{t = 0}^{T - 1} ϕ ( {x}_{t} ) {c}_{t} ( {c}_{t} ∈ A ) & \end{matrix}$$

Also, L(V_{T}) is a set of all A-linear operators from V_{T} to V_{T} (i.e., L that satisfies L(vc)=(Lv)c for any c∈A and any v∈Mₖ).

In order to solve the minimization problem shown in Formula (3) described above, an orthonormal projection from Mₖ to V_{T} is calculated. Here, an orthonormal projection P from Mₖ to V_{T} is an A-linear operator from Mₖ to V_{T} that satisfies P²=P and P=P*. P can be calculated by configuring an orthonormal system {q₀, q₁, . . . , q_{T-1}} of V_{T}. The orthonormal system {q₀, q₁, . . . , q_{T-1}} of V_{T} is a Hermitian matrix c where <qₜ,qₛ>ₖ=0 and <qₜ,qₜ>ₖ is not 0 for qₜ∈V_{T} and s≠t, and c²=c is satisfied (in this case, qₜ is called normal).

Given time series data x₀, x₁, . . . , x_{T-1}∈X, an orthonormal system {q₀, q₁, . . . , q_{T-1}} of V_{T} can be configured by sequentially executing the following Step 1 and Step 2 for t=0, 1, . . . ,T−1.

Step 1: If t=0, set ˜q₀=φ(x₀). On the other hand if t≠0, for s=0, . . . , t−1, set r_{s,t}=<φ(xₜ), qₛ>ₖ, and set ˜qₜ as follows:

$$\begin{matrix}[ Math . 12 ] & \\ {\tilde{q}}_{t} = ϕ ( {x}_{t} ) - {\sum }_{s = 0}^{t - 1} {r}_{s , t} {q}_{s} & \end{matrix}$$

Step 2: Next, let ε be a real number greater than or equal to 0, and if ∥˜qₜ∥ₖ≥ε, set qₜ=0; otherwise, the following is executed. Let eigenvalues of <˜qₜ, ˜qₜ>ₖ be λ_{t,0}≥ . . . ≥λ_{t,n-1}, and let mₜ be the maximum index that satisfies λᵢ>ε². Also, let UₜDₜUₜ* be the eigendecomposition of <˜qₜ,˜qₛ>ₖ. Here, Dₜ is a matrix having diagonal components of λ_{t,0}, . . . , λ_{t,n-1} and non-diagonal components of all zero. Uₜ is a matrix in which eigenvectors corresponding to the respective eigenvalues λ_{t,n-1} are arranged in this order. At this time, <˜qₜ, ˜qₜ>ₖ is a Hermitian positive definite matrix, and hence, if ∥˜qₜ∥ₖ>ε, has at least one positive eigenvalue greater than ε, and mₜ>0.

Therefore, let \hat{ }Dₜ be a matrix having the following diagonal components,

$$\begin{matrix}[ Math . 13 ] & \\ \frac{1}{\sqrt{{λ}_{t , 0}}} , … , \frac{1}{\sqrt{{λ}_{t , {m}_{t}}}} , 0 , … , 0 & \end{matrix}$$

and having non-diagonal components of all zero, and set bₜ=Uₜ\hat{ }DₜUₜ. Further, set qₜ=˜qₜbₜ. qₜ is normal, and hence, is an orthonormal vector.

Let Φ_{T} be an A-linear mapping to map a vector [c₀, . . . , c_{T-1}] of arrayed T elements of the C*-algebra A to the following linear combination:

$$\begin{matrix}[ Math . 14 ] & \\ {\sum }_{t = 0}^{T - 1} {q}_{t} {c}_{t} & \end{matrix}$$

Also, let B_{T} be a matrix having diagonal components of b₀, . . . , b_{T-1} and non-diagonal components of all zero, and let R_{T} be a T×T matrix having r_{s,t} as the (s,t) component. Note that each component of R_{T} is an element of A. By executing Step1 and Step2 described above, it can be shown that Q_{T}=Φ_{T}B_{T}−Q_{T}R_{T}; therefore, Q_{T}=Φ_{T}B_{T}(I+R_{T})⁻¹ where I is an identity matrix.

For Q_{T} configured as described above, Q_{T}Q_{T}* is an orthonormal projection from Mₖ to ˜V_{T} (i.e., if setting P=Q_{T}Q_{T}*, P is an orthonormal projection) where ˜V_{T} is a set of all linear combinations expressed as in the following formula:

$$\begin{matrix}[ Math . 15 ] & \\ {\sum }_{t = 0}^{T - 1} {q}_{t} {c}_{t} ( {c}_{t} ∈ A ) & \end{matrix}$$

The orthonormal projection minimizes the difference, i.e., for any element v of Mₖ and any element w of ˜V_{T}, |v−w|ₖ−|v−Pv|ₖ is positive. Also, in the case of setting c=0 at Step 2 described above, any element v of V_{T} can be expressed as follows:

$$\begin{matrix}[ Math . 16 ] & \\ v = {\sum }_{t = 0}^{T - 1} {q}_{t} {c}_{t} & \end{matrix}$$

Therefore, it can be shown V_{T}=˜V_{T}. Here, cₜ is an n×n matrix.

Therefore, it can be understood that \hat{ }K fulfilling Formula (3) described above satisfies \hat{ }Kφ(x_{T-1})=Q_{T}Q_{T}*φ(x_{T}), and satisfies \hat{ }Kφ(xₜ)=Q_{T}Q_{T}*φ(xₜ₊₁) (t=0, . . . , T−1). Meanwhile, for an element v of Mₖ, an element of V_{T} that minimizes the difference is Q_{T}Q_{T}*v. Therefore, Kv is approximated with \hat{ }KQ_{T}Q_{T}*v. Here, \hat{ }KQ_{T}Q_{T}*v can be expressed as follows:

\hat{K}Q_{T}Q_{T}*v=\hat{K}Φ_{T}B_{T}(I+R_{T})⁻¹Q*_{T}v=Q_{T}Q*_{T}Φ_{T+1}B_{T}(I+R_{T})⁻¹Q*_{T}v=Q_{T}(I+R_{T})⁻*B*_{T}Φ*_{T}Φ_{T+1}B_{T}(I+R_{T})⁻¹Q*_{T}v [Math. 17]

where, −* denotes the Hermitian transposition of an inverse matrix.

By Q_{T}, a vector of arrayed T elements of A and an element of V_{T} can be considered as identical, and hence, Q_{T} can be regarded as an operator representing a coordinate transformation. Therefore, K is approximated with a T×T matrix in which components expressed as in the following formula,

(I+R_{T})⁻*B*_{T}Φ*_{T}Φ_{T+1}B_{T}(I+R_{T})⁻¹ [Math. 18]

are elements of A. Φ_{T}*Φ_{T}+1 is a T×T matrix whose (s, t) component is k (xₛ, xₜ₊₁)∈A, and hence, the formula,

(I+R_{T})⁻*B*_{T}Φ*_{T}Φ_{T+1}B_{T}(I+R_{T})⁻¹ Math. 19]

can be calculated in practice. Therefore, ˜K_{T} is set as follows:

\tilde{K}_{T}=(I+R_{T})⁻*B*_{T}Φ*_{T}Φ_{T+1}B_{T}(I+R_{T})⁻¹ [Math. 20]

and this ˜K_{T} is referred to as an “approximate Perron-Frobenius operator”.

Thus, by using this approximate Perron-Frobenius operator ˜K_{T}, Kv can be approximated as Q_{T}˜K_{T}Q_{T}*v for any v∈Mₖ.

### (ii) The Case of X≠Y

In this case, let V_{T} be a set of all linear combinations expressed as in the following formula,

$$\begin{matrix}[ Math . 21 ] & \\ {\sum }_{t = 0}^{T - 1} {ϕ}_{1} ( {x}_{t} ) {c}_{t} ( {c}_{t} ∈ A ) & \end{matrix}$$

and let W_{T} be a set of all linear combinations expressed as in the following formula:

$$\begin{matrix}[ Math . 22 ] & \\ {\sum }_{t = 0}^{T - 1} {ϕ}_{2} ( {y}_{t} ) {c}_{t} ( {c}_{t} ∈ A ) & \end{matrix}$$

Further, in substantially the same way as in (i) described above, an orthonormal system {q₀, q₁, . . . , q_{T-1}} of VT is configured, and by using this orthonormal system {q₀, q₁, . . . , q_{T-1}}, Q_{T} is configured. Further, let \hat{ }K be a linear mapping from V_{T} to W_{T} that satisfies \hat{ }Kφ₁(xₜ)=φ₂(yₜ), to approximate Kv with \hat{ }KQ_{T}Q_{T}*v. Therefore, also for W_{T}, an orthonormal system is configured in substantially the same way as in (i) described above, and by using this orthonormal system, P_{T} is configured by a method substantially the same as the method of configuring Q_{T} described above.

Also, in substantially the same way as in (i) described above, Q_{T} is decomposed as Q_{T}=Φ_{T}B_{T}(I+R_{T})−1 where Φ_{T} is an A-linear mapping that maps a vector [c₀, . . . , c_{T-1}] of arrayed T elements of A to the following linear combination:

$$\begin{matrix}[ Math . 23 ] & \\ {\sum }_{t = 0}^{T - 1} {ϕ}_{1} ( {x}_{t} ) {c}_{t} & \end{matrix}$$

In substantially the same way, P_{T} is decomposed as P_{T}=Ψ_{T}C_{T}(I+S_{T})⁻¹ where Ψ_{T} is an A-linear mapping that maps a vector [c₀, . . . , c_{T-1}] of arrayed T elements of A to the following linear combination:

$$\begin{matrix}[ Math . 24 ] & \\ {\sum }_{t = 0}^{T - 1} {ϕ}_{2} ( {y}_{t} ) {c}_{t} & \end{matrix}$$

Also, C_{T} is a T×T matrix with respect to W_{T}, configured by a method substantially the same as the method of configuring B_{T} described above. Similarly, S_{T} is a T×T matrix with respect to W_{T}, configured by a method substantially the same as the method of configuring R_{T} described above.

At this time, as \hat{ }Kφ₁(xₜ)=φ₂(yₜ) is satisfied, \hat{ }KΦ_{T}=ωT is derived; therefore, K is approximated with a T×T matrix that has components of elements of A, and is expressed as follows:

P*_{T}\hat{K}Q_{T}=(I+S_{T})−*C*_{T}Ψ*_{T}Ψ_{T}B_{T}(I+R_{T})⁻¹ [Math. 25]

In other words, the approximate Perron-Frobenius operator is set as follows:

\tilde{K}_{T}=(I+S_{T})⁻*C*_{T}Ψ*_{T}Ψ_{T}B_{T}(I+R_{T})⁻¹ [Math. 26]

### <<Decomposition of Approximate Perron-Frobenius Operator>>

As described above, an A-valued positive definite kernel k is configured with a complex-valued positive definite kernel ˜k, and is an n×n matrix in which each component takes a complex value. Therefore, letting C be the complex number field, the approximate Perron-Frobenius operator ˜K_{T} can be regarded as ˜K_{T}∈C^{nT×nT}.

Here, assume that there exist eigenvalues ˜λ₀, . . . , ˜λ_{nT-1} and corresponding eigenvectors ˜v₀, . . . , ˜v_{nT-1} for the approximate Perron-Frobenius operator ˜K_{T}. By setting vₘ=[˜vₘ, 0, . . . , 0] and λₘ=diag{˜λₘ, 0, . . . , 0}, ˜K_{T}vₘ=vₘλₘ is satisfied. Also, if [˜v₁, . . . , ˜v_{nT-1}] is invertible, the following formula holds:

$$\begin{matrix}[ Math . 27 ] & \\ {Q}_{T}^{*} ϕ ( {x}_{0} ) = {\sum }_{m = 0}^{nT - 1} {v}_{m} {c}_{m} ( {c}_{m} ∈ A ) & \end{matrix}$$

Here, by the definition of K, φ(xₜ)=K^{t}φ(x₀) holds. Therefore, by using an approximate Perron-Frobenius operator, φ(xₜ) is approximated with Q_{T}˜K_{T}tQ_{T}*φ(x₀). Similarly, by using an approximate Perron-Frobenius operator, φ(xₛ) is approximated with Q_{T}˜K_{T}^{s}Q_{T}*φ(x₀).

Then, k (xₜ, xₛ)=<φ(xₜ), φ(xₛ)>ₖ can be approximated as in the following Formula (4):

$$\begin{matrix}[ Math . 28 ] & \\ {〈 ϕ ( {x}_{t} ) , ϕ ( {x}_{s} ) 〉}_{k} \approx {〈 {Q}_{T} {\tilde{K}}_{T}^{t} {\sum }_{m = 0}^{nT - 1} {v}_{m} {c}_{m} , {Q}_{T} {\tilde{K}}_{T}^{s} {\sum }_{m = 0}^{nT - 1} {v}_{m} {c}_{m} 〉}_{k} & ( 4 )\end{matrix}$$

$$= 〈 {\tilde{K}}_{T}^{t} {\sum }_{m = 0}^{nT - 1} {v}_{m} {c}_{m} , {\tilde{K}}_{T}^{s} {\sum }_{m = 0}^{nT - 1} {v}_{m} {c}_{m} 〉$$

$$= 〈 {\sum }_{m = 0}^{nT - 1} {v}_{m} {λ}_{m}^{t} {c}_{m} , {\sum }_{m = 0}^{nT - 1} {v}_{m} {λ}_{m}^{s} {c}_{m} 〉$$

$$= {\sum }_{m , {m}^{′} = 0}^{nT - 1} {{c}_{m}^{*} ( {λ}_{m}^{*} )}^{t} 〈 {v}_{m} , {v}_{{m}^{′}} 〉 {λ}_{{m}^{′}}^{s} {c}_{{m}^{′}}$$

$$= {\sum }_{m , {m}^{′} = 0}^{nT - 1} {\tilde{\tilde{λ}}}_{m}^{t} {\tilde{λ}}_{{m}^{′}}^{s} ( {\tilde{v}}_{m}^{*} {\tilde{v}}_{{m}^{′}} ) {c}_{m}^{*} {c}_{{m}^{′}}$$

where for uₘ and vₘ, <uₘ, vₘ≥uₘ*vₘ.

By approximation and decomposition executed in this way, for example, it becomes possible to analyze the behavior when having s,t→∞; the cycle of change in k(xₜ,xₛ) (i.e., a matrix in which each (i,j) component represents the proximity between the i-th component of xₜ and the j-th component of xₛ); and the like.

### <Functional Configuration of Relationship Extraction Device 10>

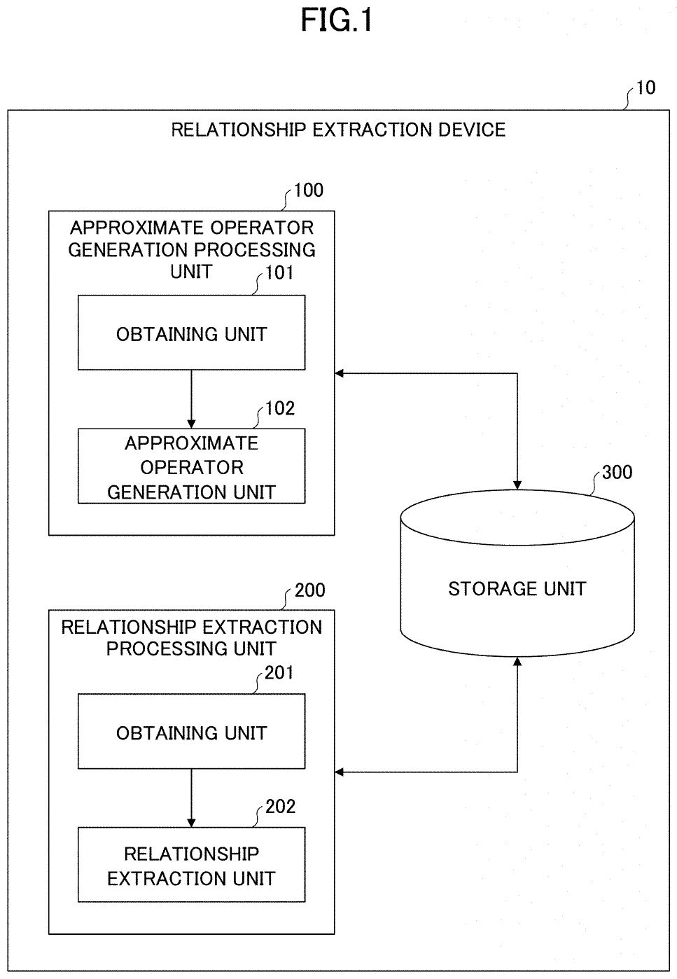

Next, a functional configuration of the relationship extraction device 10 according to the present embodiment will be described with reference to FIG. 1. FIG. 1 is a diagram illustrating an example of a functional configuration of the relationship extraction device 10 according to the present embodiment.

As illustrated in FIG. 1, the relationship extraction device 10 according to the present embodiment includes an approximate operator generation processing unit 100, a relationship extraction processing unit 200, and a storage unit 300.

The storage unit 300 stores a set of data {x₀, x₁, . . . ,x_{T-1}} each having multiple elements. Also, in the storage unit 300, an approximate Perron-Frobenius operator ˜K_{T} generated by the approximate operator generation processing unit 100, and relationships extracted by the relationship extraction processing unit 200 are stored (i.e., an n×n matrix as an approximation result shown in Formula (4) described above).

The approximate operator generation processing unit 100 takes as input a set of data {x₀, x₁, . . . , x_{T-1}} each having multiple elements, and executes an approximate operator generation process of generating an approximate Perron-Frobenius operator ˜K_{T}. Here, the approximate operator generation processing unit 100 includes an obtaining unit 101 and an approximate operator generation unit 102. The obtaining unit 101 obtains the set of data {x₀, x₁, . . . , x_{T-1}} each having multiple elements from the storage unit 300. The approximate operator generation unit 102 generates an approximate Perron-Frobenius operator ˜K_{T} from {x₀, x₁, . . . , x_{T-1}} obtained by the obtaining unit 101.

The relationship extraction processing unit 200 takes as input data xₛ and xₜ as targets of relationship extraction, and executes a relationship extraction process to extract relationships between the data. Here, the relationship extraction processing unit 200 includes an obtaining unit 201 and a relationship extraction unit 202.

The obtaining unit 201 obtains the data xₛ and xₜ as targets of relationship extraction from the storage unit 300. The relationship extraction unit 202 extracts relationships between the obtained xₛ and xₜ by the obtaining unit 201.

Note that the configuration of the relationship extraction device 10 illustrated in FIG. 1 is an example, and another configuration may be adopted. For example, the approximate operator generation processing unit 100 and the relationship extraction processing unit 200 may be included in different devices or equipment.

### <Approximate Operator Generation Process>

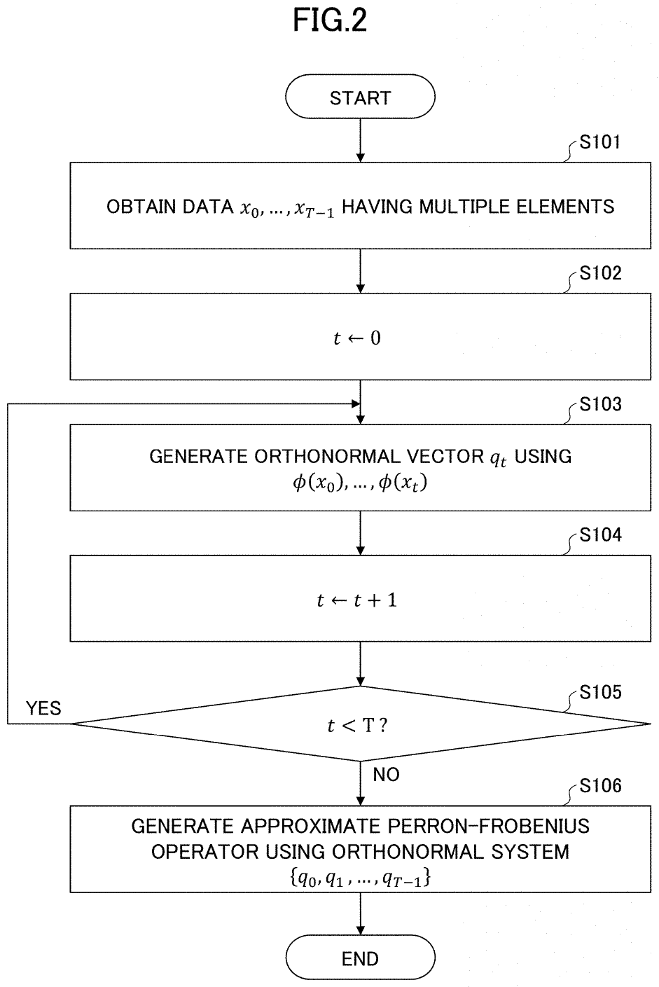

Next, an approximate operator generation process according to the present embodiment will be described with reference to FIG. 2. FIG. 2 is a flow chart illustrating an example of an approximate operator generation process according to the present embodiment.

The obtaining unit 101 of the approximate operator generation processing unit 100 obtains data each having multiple elements from the storage unit 300 (also obtains y₀, y₁, . . . , y_{T-1} in the case of (ii) described above) (Step S101).

Next, the approximate operator generation unit 102 of the approximate operator generation processing unit 100 sets t←0 where t is an index indicating the data obtained at Step S101 described above (Step S102).

Next, the approximate operator generation unit 102 of the approximate operator generation processing unit 100 generates an orthonormal vector qₜ by using φ(x₀), . . . , φ(xₜ) as described in the above (i) and (ii) (φ₁(x₀), . . . , φ₁(xₜ) in the case of (ii) described above) (Step S103). Note that an orthonormal vector of W_{T} is also generated in the case of (ii) described above.

Next, the approximate operator generation unit 102 of the approximate operator generation processing unit 100 sets t←t+1 (Step S104). Further, the approximate operator generation unit 102 of the approximate operator generation processing unit 100 determines whether t<T (Step S105).

If t<T is determined at Step S105 described above, the approximate operator generation unit 102 of the approximate operator generation processing unit 100 returns to Step S103. Thus, for t=0, . . . , T−1, Step S103 described above is executed, and the orthonormal system {q₀, q₁, . . . , q_{T-1}} is obtained. Note that in the case of (ii) described above, the orthonormal system of W_{T} is also obtained.

If t<T is not determined at Step S105 described above, the approximate operator generation unit 102 of the approximate operator generation processing unit 100 generates an approximate Perron-Frobenius operator ˜K_{T} by using the orthonormal system {q₀, q₁, . . . , q_{T-1}} as described in the above (i) and (ii) (also using the orthonormal system of W_{T} in the case of (ii)) (Step S106).

### <Relationship Extraction Process>

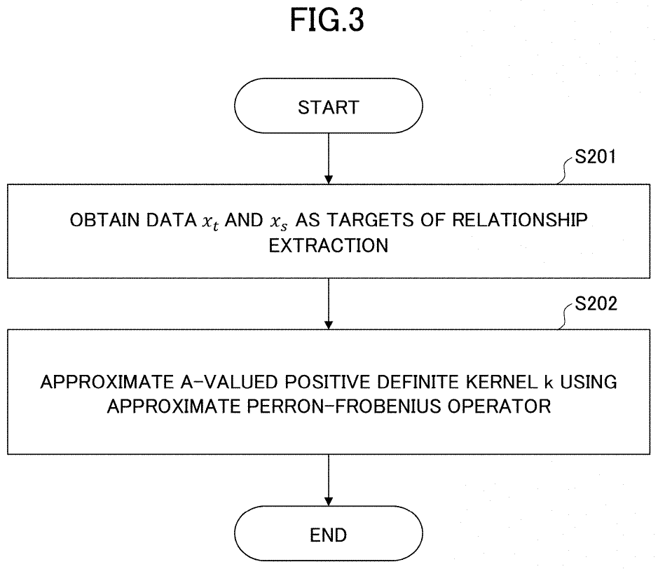

Next, a relationship extraction process according to the present embodiment will be described with reference to FIG. 3. FIG. 3 is a flow chart illustrating an example of a relationship extraction process according to the present embodiment.

The obtaining unit 201 of the relationship extraction processing unit 200 obtains the data xₛ and xₜ as targets of relationship extraction from the storage unit 300 (Step S201).

Next, the relationship extraction unit 202 of the relationship extraction processing unit 200 extracts relationships between the obtained xₛ and xₜ obtained at Step S101 described above (Step S102). In other words, the relationship extraction unit 202 approximates k(xₜ,xₛ)=<φ(xₜ), φ(xₛ)>ₖ by Formula (4) described above (Step S202). Accordingly, an n×n matrix is obtained in which each (i,j) component represents the proximity between the i-th component of xₜ and the j-th component of xₛ (i.e., the relationship between x_{t,i} and x_{s,j}), and the relationships between xₛ and xₜ are extracted.

### Application Examples

In the following, several application examples using the approximate Perron-Frobenius operator will be described.

### <<Anomaly Detection>>

Suppose that each of x₀, x₁, . . . , x_{T-1} ∈X has n items of time series data. In other words, suppose that xₜ includes x_{t,0}, . . . , x_{t,n-1} as n items of time series data, denoted as xₜ=[x_{t,0}, . . . , x_{t,n-1}]. In the case where φ(xₜ) has been obtained, φ(xₜ₊₁) can be predicted by using an approximate Perron-Frobenius operator ˜K_{T} obtained by the method described in (i) described above. This prediction can be obtained by Q_{T}˜K_{T}Q_{T}*φ(xₜ) as described above.

At this time, assuming that the following equation holds,

$$\begin{matrix}[ Math . 29 ] & \\ {\tilde{K}}_{T} {Q}_{T}^{*} ϕ ( {x}_{t} ) = {\sum }_{s = 0}^{T - 1} ϕ ( {x}_{s} ) {c}_{s} & \end{matrix}$$

Each (j,j) component of the following formula,

$$\begin{matrix}[ Math . 30 ] & \\ {\vert {\sum }_{s = 0}^{T - 1} ϕ ( {x}_{s} ) {c}_{s} - ϕ ( {x}_{t} ) \vert}_{k}^{2} & \end{matrix}$$

is equivalent to the following:

$$\begin{matrix}[ Math . 31 ] & \\ {‖ {\sum }_{s = 0}^{T - 1} {\sum }_{i = 0}^{n - 1} {( {c}_{s} )}_{i , j} \tilde{ϕ} ( {x}_{s , i} ) - \tilde{ϕ} ( {x}_{t , i} ) ‖}_{\tilde{k}} & \end{matrix}$$

where ˜φ is a feature map with respect to ˜k, and (cₛ)_{i,j} is the (i,j) component of cₛ being an n×n matrix.

Therefore, in the case where the (j,j) component of the following formula is large,

$$\begin{matrix}[ Math . 32 ] & \\ {\vert {\sum }_{s = 0}^{T - 1} ϕ ( {x}_{s} ) {c}_{s} - ϕ ( {x}_{t} ) \vert}_{k}^{2} & \end{matrix}$$

it can be understood that an anomaly occurs in the j-th data item in the n items of time series data.

### <<Causal Estimation (Part 1)>>

For n items of time series data, x₀, x₁, . . . , x_{T-1}∈X are defined such that x_{s,i+m″n} is data at time s+m″ of the i-th item of the time series data. At this time, consider the case of t=s in Formula (4) described above. For ˜λₘ having a magnitude close to 1,

\overline{\tilde{λ}}ₘ^{s}\overline{\tilde{λ}}ₘ^{s}(\tilde{v}*ₘ\tilde{v}ₘ)c*ₘcₘ [Math. 33]

is unchanged by the change in s; therefore, for ˜λₘ having the magnitude close to 1, in the sum of Formula (4) described above, by calculating only the following,

\overline{\tilde{λ}}ₘ^{s}\overline{\tilde{λ}}ₘ^{s}(\tilde{v}*ₘ\tilde{v}ₘ(c*ₘcₘ [Math. 34]

An unchanged part regardless of the change in s in the approximation of k(xₛ,xₛ) (the proximity between xₛ and xₛ) can be extracted. Therefore, if the value of the (i,j+m″n) component of the sum is large, then, x_{s,i} and x_{s,j+m″n} are close regardless of s; conversely, if the value of the component (i,j+m″n) is small, then x_{s,i} and x_{s,j+m″n} are distant regardless of s. In other words, it can be understood that the change in the i-th data from among the n items of time series data is a cause of the change in the j-th data.

### <<Causal Estimation (Part 2)>>

Suppose that each of x₀, x₁, . . . , x_{T-1}∈X has n items of time series data. In the case where the change in j-th data from among the n items of time series data is a cause of the change in i-th data, consider data ˜x₀, ˜x₁, . . . , ˜x_{T-1} each obtained by removing the j-th component in xₜ (t=0, . . . , T−1). In other words, it is set as ˜xₜ=[x_{t,0}, . . . , x_{t,j-1}, x_{t,j+1}, . . . , x_{t,n-1}]

At this time, in the case of considering that ˜K_{T} is generated with ˜x₀, ˜x₁, . . . , ˜x_{T-1} to predict ˜xₛ for S≥T, this prediction is calculated by Q_{T}˜K_{T}Q_{T}*φ(˜xₛ₋₁); however, among the components of ˜xₛ, it is expected that the component corresponding to the i-th data is not approximated well. Therefore, by comparing the components of the following formula,

|Q_{T}\tilde{K}_{T}Q*_{T}ϕ(\tilde{x}_{S-1})−ϕ(\tilde{x}_{S})|ₖ² [Math. 35]

data that changes due to the change in the j-th data as the cause can be identified. In other words, in the case where the (i,i) component of the following formula is large,

|Q_{T}\tilde{K}_{T}Q*_{T}ϕ(\tilde{x}_{S-1})−ϕ(\tilde{x}_{S})|ₖ² [Math. 36]

it can be understood that the change in the j-th data is the cause of the change in the i-th data. In the Granger causality, a linear relationship is assumed between items of data in time series data, whereas the method according to the present embodiment can estimate with good precision even for a nonlinear relationship.
<<Behavior of Proximity Between Elements when t→∞>>

In Formula (4) described above, the term corresponding to ˜λₘ=1 becomes a constant value when t→∞, and a term corresponding to |˜λₘ|<1 becomes zero when t→∞. Therefore, in Formula (4) described above, by setting ˜λₘ not being 1 to 0, the behavior of the proximity between elements when t→∞ can be understood.

### <Other Data Analysis Methods Using RKHM>

Kernel PCA will be described as one of modified examples of the present embodiment. Let x₀, x₁, . . . , x_{T-1}∈X be data each having n elements. By using the same notations as used in Step 2 described above, ˜bₜ is defined as ˜bₜ=UₜDₜUₜ where Dₜ is a matrix having diagonal components of

\sqrt{λ_{t,0}}, . . . ,\sqrt{λ_{t,m}_{ₜ}},0, . . . ,0 [Math. 37]

and having non-diagonal components of all zero. Let ˜Bₘ be a matrix having diagonal components of ˜b₀, . . . , ˜bₘ₋₁ and non-diagonal components of all zero. In the case of setting ε=0, Φₘ=Qₘ(˜Bₘ+Rₘ) holds. Also, it can be shown that Cm that satisfies Qₘ*Qₘ=CₘCₘ* exists. Therefore, by calculating the singular value decomposition as Cₘ*Rₘ=UₘΣₘVₘ*, and setting w₁=QₘCₘu₁, it can be shown that under a condition of vₜ being normal, w₁ is a vector that maximizes the following formula:

$$\begin{matrix}[ Math . 38 ] & \\ {\sum }_{t = 0}^{m - 1} {‖ w {〈 w , {v}_{t} 〉}_{k} ‖}_{k}^{2} & \end{matrix}$$

where uₜ represents a t-th column of Uₘ. Also, vₜ is expressed as follows:

$$\begin{matrix}[ Math . 39 ] & \\ {v}_{t} = ϕ ( {x}_{t} ) - {\sum }_{s = 0}^{m - 1} ϕ ( {x}_{s} ) & \end{matrix}$$

Therefore, it can be stated that w₁ is a vector that best approximates the residual on the RKHM, and this w₁ will be referred to as the first principal vector. Similarly, wₜ=QₘCₘUₜ will be referred to as a t-th principal vector. Denoting non-zero eigenvalues of Φₘ*Φₘ (a T×T matrix whose (s, t) component is k(xₛ, xₜ₊₁)∈A) as λ₀≥ . . . ≥λ₁>0, and the corresponding eigenvectors as v₀, . . . ,v₁, it can be shown wₜ=λₜ^{-1/2}Φₘvₜ; therefore, calculation is carried out in practice in this way. The proximity between data φ(xₛ) and the t-th principal vector can be expressed as <wₜ,φ(xₛ)>ₖ, and hence, <wₜ,φ(xₛ)>ₖ can be regarded as the t-th principal component of φ(xₛ). However, <wₜ,φ(xₛ)>ₖ takes a matrix value, and hence, instead of <wₜ,φ(xₛ)>ₖ, for example, by using ∥<wₜ,φ(xₛ)≥ₖ∥, a distribution of the data can be visualized. For example, visualization in the two-dimensional plane can be achieved by taking ∥<w₁,φ(xₛ)>ₖ∥ in the horizontal axis and ∥<wₜ,φ(xₛ)>ₖ∥ in the vertical axis, and plotting the data. Also, by replacing φ(xₛ) with the following formula,

$$\begin{matrix}[ Math . 40 ] & \\ ϕ ( {x}_{s} ) - {\sum }_{t = 0}^{m - 1} ϕ ( {x}_{t} ) & \end{matrix}$$

a centralized kernel PCA can be executed as in the case of general kernel PCA using the RKHS.

### <Evaluation>

Next, evaluation of the method according to the present embodiment will be described.

### <<Goodness of Prediction>>

A Kuramoto model on [0,2Π) shown in the following Formula (5) was considered.

$$\begin{matrix}[ Math . 41 ] & \\ \frac{d {θ}_{i}}{dt} = {ω}_{i} + \frac{κ}{n} {\sum }_{j = 0}^{n - 1} sin ( {θ}_{j} - {θ}_{i} ) & ( 5 )\end{matrix}$$

where θᵢ(0) was assumed to be a random number following a uniform distribution on [0, 2Π), and ωᵢ was also assumed to be a random number following the uniform distribution on [0, 2Π).

A dynamical system shown in the following Formula (6) obtained by discretizing Formula (5) described above was considered.

$$\begin{matrix}[ Math . 42 ] & \\ {x}_{t , i} = {x}_{t - 1 , i} + Δ t {ω}_{i} + Δ t \frac{κ}{n} {\sum }_{j = 0}^{n - 1} sin ( {x}_{t - 1 , j} - {x}_{t - 1 , i} ) & ( 6 )\end{matrix}$$

Here, on [0, 2Π), the following function was considered,

\tilde{k}(x,y)=e^{-|e}^{^{ix}}^{-e}^{^{iy}}^{|} [Math. 43]

where the (i,j) component of k(xₜ,xₛ) was set to ˜k(x_{t,i},x_{s,j}), and Δt=0.01. Also, parameters were also set as n=200, T=10, and mₜ=jₜ upon normalization. At this time, for S=100, the magnitude |Q_{T}˜K_{T}Q_{T}*φ(xₛ₋₁)|ₖ of a predicted value was calculated in the cases of a parameter κ representing the strength of interrelation set to κ=1, 10.

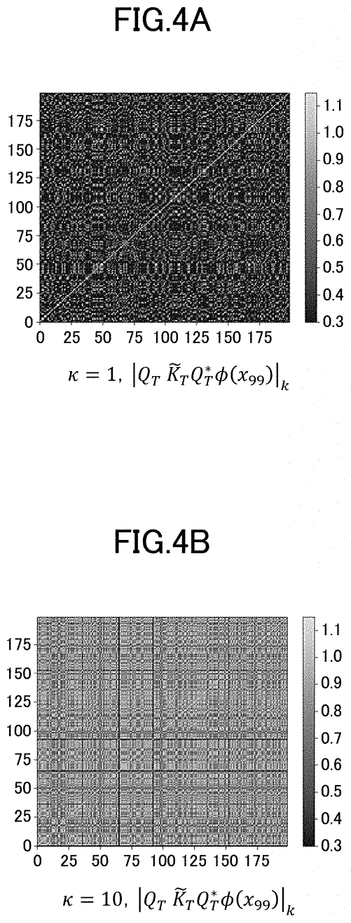

A result of plotting values of the respective components of |Q_{T}˜K_{T}Q_{T}*φ(xₛ₋₁)|_{K}, in the case of κ=1 is illustrated in FIG. 4A. Also, a result of plotting values of the respective components of |Q_{T}˜K_{T}Q_{T}*φ(xₛ₋₁)|ₖ in the case of κ=10 is illustrated in FIG. 4B. Q_{T}-K_{T}Q_{T}*φ(xₛ₋₁) is an approximation of φ(xₛ); therefore, the (i,j) component of |Q_{T}˜K_{T}Q_{T}*φ(x_{S-1})|ₖ is considered to be the (i,j) component of k(xₛ,xₛ), i.e., an approximation of ˜k(x_{s,i},x_{s,j}). Therefore, if x_{s,i} and x_{s,j} are closer to each other, the (i,j) components of |Q_{T}˜K_{T}Q_{T}*φ(xₛ₋₁)|ₖ should become greater, or if x_{s,i} and x_{s,j} are apart further, the (i,j) components of |Q_{T}˜K_{T}Q_{T}*φ(xₛ₋₁)|ₖ should become smaller.

In FIG. 4B, (i,j) components are uniformly greater compared to those in FIG. 4A (i.e., a greater value of K resulted in uniformly greater (i,j) components). Therefore, the value of each component of the predicted value at time S is aligned. In the Kuramoto model, as a certain length of time elapses, the greater K resulted in better aligned values of the elements; therefore, it can be understood that the approximation was obtained precisely.

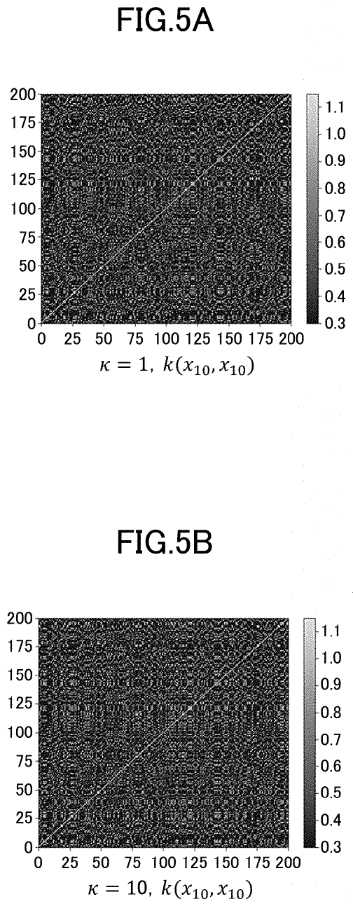

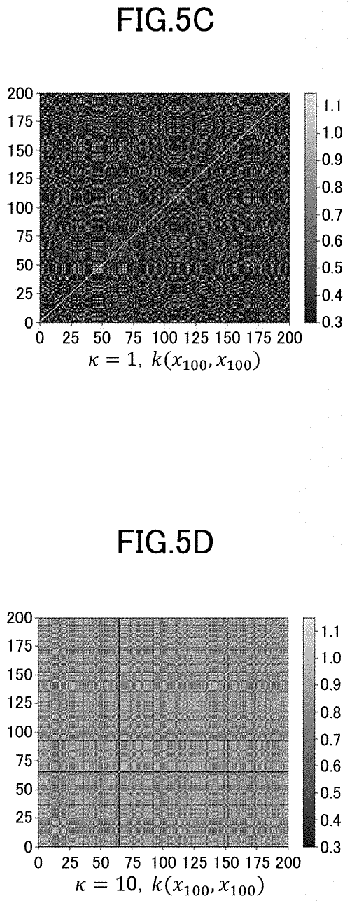

In fact, in the case of κ=1, 10, results of calculating k (x₁₀, x₁₀) and k (x₁₀₀, x₁₀₀) for x₁₀ and x₁₀₀, respectively, obtained directly from Formula (6) described above are illustrated in FIGS. 5A to 5D. Comparing FIG. 4A with FIG. 5C, and FIG. 4B with FIG. 5D, respectively, it can be understood that close values are obtained. Also, comparing FIG. 4B with FIG. 5B and FIG. 5D, although at t=10, these are not yet completely synchronized, by using ˜K_{T} approximated by using data up to t=10, it can be understood the state of t=100 being sufficiently synchronized is predicted.

<<Behavior of Proximity Between Elements when t→∞>>

A Kuramoto model on [0,2Π) shown in the following Formula (7) was considered.

$$\begin{matrix}[ Math . 44 ] & \\ \frac{d {θ}_{i}}{dt} = {ω}_{i} + \frac{1}{n} {\sum }_{j = 0}^{n - 1} {κ}_{i , j} sin ( {θ}_{j} - {θ}_{i} ) & ( 7 )\end{matrix}$$

where θᵢ(0) was assumed to be a random number following a uniform distribution on [0, 2Π), and ωᵢ was also assumed to be a random number following the uniform distribution on [0, 2Π).

A dynamical system shown in the following Formula (8) obtained by discretizing Formula (7) described above was considered.

$$\begin{matrix}[ Math . 45 ] & \\ {x}_{t , i} = {x}_{t - 1 , i} + Δ t {ω}_{i} + Δ t \frac{1}{n} {\sum }_{j = 0}^{n - 1} {κ}_{i , j} sin ( {x}_{t - 1 , j} - {x}_{t - 1 , i} ) & ( 8 )\end{matrix}$$

Here, on [0, 2Π), the following function was considered,

\tilde{k}(x,y)=e^{-|e}^{^{ix}}^{-e}^{^{iy}}^{|} [Math. 46]

where the (i,j) component of k(xₜ,xₛ) was set to ˜k(x_{t,i},x_{s,j}), and Δt=0.01. Also, ˜K_{T} was calculated with n=50, T=10, and mₜ=jₜ upon normalization. Further, under each of the following Setting 1 and Setting 2, Formula (4) described above was calculated. Here, when calculating Formula (4) described above, zero was assumed except for ˜λₘ close to 1.
Setting 1: In the case of i>25 and j>25, κ_{i,j}=100; otherwise κ_{i,j}=0
Setting 2: In the case of (i<25 or i>35) and (j<25 or j>35), κ_{i,j}=100; otherwise κ_{i,j}=0

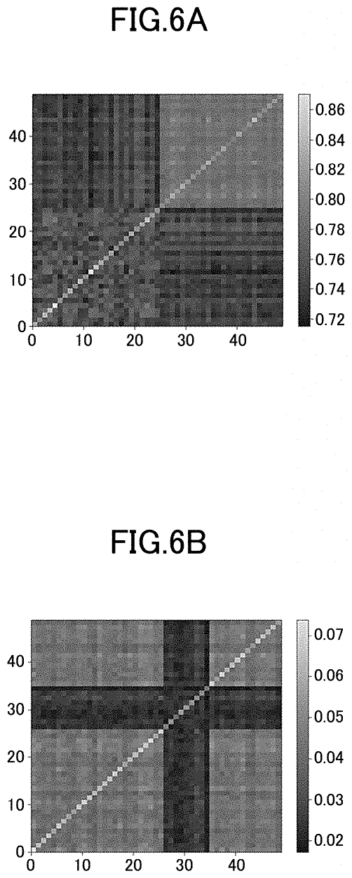

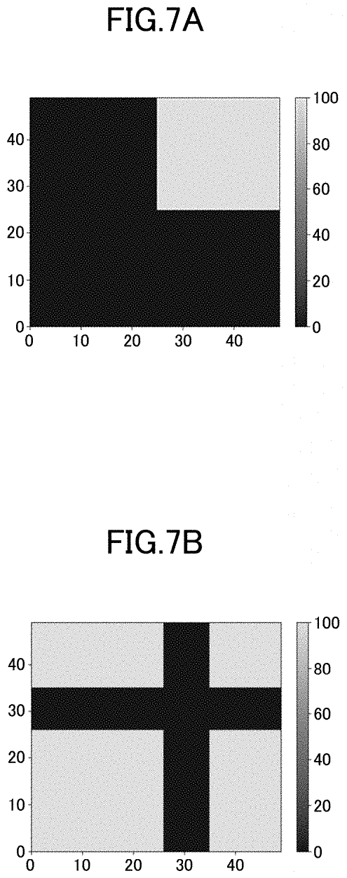

A result of calculating Formula (4) described above and plotting values of the respective components of the calculated result under Setting 1 described above is illustrated in FIG. 6A. Also, a result of calculating Formula (4) described above and plotting values of the respective components of the calculated result under Setting 2 described above is illustrated in FIG. 6B. Also, taking i in the vertical axis and j in the horizontal axis, a result of plotting the magnitudes of κ_{i,j} under Setting 1 described above is illustrated in FIG. 7A. Similarly, a result of plotting the magnitudes of κ_{i,j} under Setting 2 described above is illustrated in FIG. 7B. In the Kuramoto model, elements interacting each other take closer values as time has elapsed sufficiently longer (i.e., elements having large values of κ_{i,j}). Therefore, it can be understood that the behavior of the proximity when t→∞ can be approximated.

### <Hardware Configuration of Relationship Extraction Device 10>

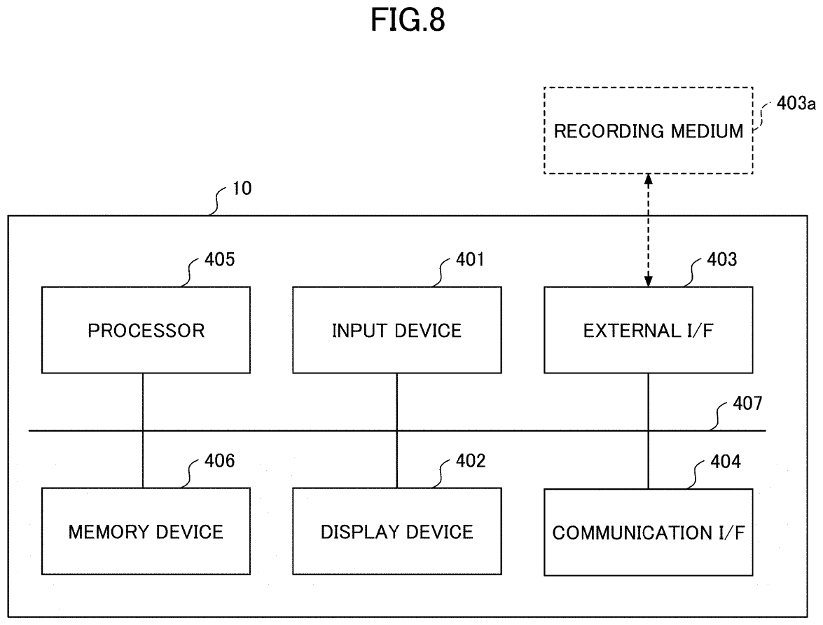

Finally, a hardware configuration of the relationship extraction device 10 according to the present embodiment will be described with reference to FIG. 8. FIG. 8 is a diagram illustrating an example of a hardware configuration of the relationship extraction device 10 according to the present embodiment.

As illustrated in FIG. 8, the relationship extraction device 10 according to the present embodiment is implemented by a generic computer or computer system, and includes an input device 401, a display device 402, an external I/F 403, a communication I/F 404, a processor 405, and a memory device 406. These hardware components are connected via a bus 407 so as to be capable of communicating with each other.

The input device 401 is, for example, a keyboard, a mouse, a touch panel, and the like. The display device 402 is, for example, a display or the like. Note that the relationship extraction device 10 may or may not have at least one of the input device 401 and the display device 402.

The external the I/F 403 is an interface with an external device. The external I/F 403 is an interface with an external device. The external device includes a recording medium 403a or the like. The relationship extraction device 10 can execute read and write with the recording medium 403a via the external I/F 403. The recording medium 403a may store, for example, one or more programs that implement the approximate operator generation processing unit 100 and the relationship extraction processing unit 200.

Note that the recording medium 403a includes, for example, CD(Compact Disc), DVD(Digital Versatile Disk), SD memory card (Secure Digital memory card), USB(Universal Serial Bus) memory card, and the like.

The communication I/F 404 is an interface for connecting the relationship extraction device 10 to a communication network. Note that one or more programs that implements the approximate operator generation processing unit 100 and relationship extraction processing unit 200 may be obtained (downloaded) from a predetermined server device or the like via the communications I/F 404.

The processor 405 is any of various types of arithmetic/logic devices, for example, a CPU(Central Processing Unit), a GPU(Graphics Processing Unit), and the like. The approximate operator generation processing unit 100 and the relationship extraction processing unit 200 are implemented by, for example, a process in which one or more programs stored in the memory device 406 causes the processor 405 to execute.

The memory device 406 is any of various types of storage devices such as, for example, an HDD (Hard Disk Drive), SSD (Solid State Drive), RAM (Random Access Memory), ROM (Read-Only Memory), flash memory, and the like. The storage unit 300 is implemented by, for example, the memory device 406. However, the storage unit 300 may be implemented by, for example, a storage device connected to the relationship extraction device 10 through a communication network.

By having the hardware configuration illustrated in FIG. 8, the relationship extraction device 10 according to the present embodiment can implement the approximate operator generation process and the relationship extraction process described above. Note that the hardware configuration illustrated in FIG. 8 is an example, and the relationship extraction device 10 may have another hardware configuration. For example, the relationship extraction device 10 may have more than one processors 405 or more than one memory devices 406.

The present invention is not limited to the embodiments described above that have been specifically disclosed, and various modifications, changes, combinations with known techniques, and the like can be made within a range not deviating from the description of the claims.

The present application is based on a base application No. 2020-035051 filed in Japan on Mar. 2, 2020, the entire contents of which are hereby

### INCORPORATED BY REFERENCE

### List of Reference Numerals

10 relationship extraction device
100 approximate operator generation processing unit
101 obtaining unit
102 approximate operator generation unit
200 relationship extraction processing unit
201 obtaining unit
202 relationship extraction unit
300 storage unit
401 input device
402 display device
403 external I/F
403a recording media
404 communication I/F
405 processor
406 memory device
407 bus

1. A relationship extraction device comprising:
a memory; and
a processor configured to execute
a obtaining a set of data {x₀, . . . , x_{T-1}}□X each having multiple elements and a set of data {y₀=f(x₀), . . . , y_{T-1}=f(x_{T-1})}□Y each having multiple elements, where f is any mapping;
generating an approximate operator that approximates a Perron-Frobenius operator K satisfying Kφ₁(xₜ)=φ₂(yₜ) for t=0, . . . , T−1, wherein φ₁ is a feature mapping with respect to a positive definite kernel function k₁ on X×X that takes C*-algebra values, and φ₂ is a feature mapping with respect to a positive definite kernel function k₂ on Y×Y that takes C*-algebra values;
obtaining data xₜ and xₛ as targets of relationship extraction; and
extracting a relationship between each element of xₜ and each element of xₛ by using the approximate operator.

2. The relationship extraction device as claimed in claim 1, wherein the extracting extracts the relationship for analyzing anomaly detection or causal estimation.

3. The relationship extraction device as claimed in claim 1, wherein the extracting extracts a C*-algebra value representing the relationship, by approximating an inner product <xₜ, xₛ>ₖ defined on an RKHM (reproducing kernel Hilbert C*-module) with respect to the positive definite kernel function k₁, by the approximate operator.

4. The relationship extraction device as claimed in claim 1, wherein in a case of X=Y, yₜ=xₜ₊₁, k₁=k₂=k, and φ₁=φ₂=φ, the generating generates the approximate operator by using an operator \hat{ }K with which \hat{ }Kφ(x_{T-1}) approximates φ(x_{T}), and an orthonormal projection from an RKHM with respect to a positive definite kernel function K to a space represented by a linear combination of φ(xₜ) and C*-algebra values.

5. The relationship extraction device as claimed in claim 1, wherein in a case of X≠Y, the generating generates the approximate operator by using a linear mapping \hat{ }K with which \hat{ }Kφ₁(xₜ) approximates φ₂(yₜ), and an orthonormal projection from an RKHM with respect to the positive definite kernel function k₁ to a space represented by a linear combination of φ₁(xₜ) and C*-algebra values.

6. A method of extracting relationship executed by a computer including a memory and a processor, the method comprising:
obtaining a set of data {x₀, . . . , x_{T-1}}□X each having multiple elements and a set of data {y₀=f(x₀), . . . , y_{T-1}=f(x_{T-1})}□Y each having multiple elements, where f is any mapping;
generating an approximate operator that approximates a Perron-Frobenius operator K satisfying Kφ₁(xₜ)=φ₂(yₜ) for t=0, . . . , T−1, wherein (pi is a feature mapping with respect to a positive definite kernel function k₁ on X×X that takes C*-algebra values, and φ₂ is a feature mapping with respect to a positive definite kernel function k₂ on Y×Y that takes C*-algebra values;
obtaining data xₜ and xₛ as targets of relationship extraction; and
extracting a relationship between each element of xₜ and each element of xₛ by using the approximate operator.

7. A non-transitory computer-readable recording medium having computer-readable instructions stored thereon, which when executed, cause a computer to function as the relationship extraction device as claimed in claim 1.
